(19) United States
(12) Patent Application Publication
(10) Pub. No.: US 2012/0111855 A1
(43) Pub. Date: May 10, 2012

(54) MODULAR INDUCTION HEATER SYSTEM

(76) Inventors: Benjamin Provoost, Tours (FR); Sebastien David, Ouderkerk a/d Amstel (NL); Peter Potveer, Amsterdam (NL)

(21) Appl. No.: 13/384,252

(22) PCT Filed: Jul. 15, 2009
(86) PCT No.: PCT/EP2009/005141

§ 371 Date: Jan. 16, 2012

(51) Int. Cl. H05B 6/04

(52) U.S. Cl. 219/661

(57) ABSTRACT

An electrically conductive physical object, e.g., a rolling-elements bearing, is inductively heated by using a first primary coil around a first core for inducing a first electrical current in the object; and a second primary coil around a second core, different from the first core, for inducing a second electrical current in the electrically conductive material. The first and second primary coils are electrically connected in parallel and the parallel connection is driven from a single switched-mode power supply.

### FIELD OF THE INVENTION

The invention relates to a system for inductively heating a physical object comprising an electrically conductive material. The invention also relates to a method of inductively heating such a physical object, and to a power supply module for use in the system.

### BACKGROUND ART

Examples of technical fields, wherein heating of a work piece is professionally applied, are the fields of rolling-element bearings and wheeled railroad equipment.

In the field of rolling-element bearings, consider mounting a rolling-element bearing on a shaft. It is a common technique to heat up a bearing so as to cause a thermal expansion in order to facilitate sliding the expanded bearing on the shaft and positioning it properly on the shaft. When, upon being positioned, the bearing cools down, the bearing contracts and eventually couples mechanically to the shaft through a shrink fit (or: interference fit).

In the field of railroad equipment, consider the drive wheels of a locomotive, or the wheels of a wagon. Such a wheel is usually made of steel and is either solid, spoked or made of a number of box sections (“boxpok”). A replaceable steel tire is fitted to the wheel. The tire forms the contact surface of the wheel with the track and is therefore subject to wear. Replacing a tire is more cost-efficient than replacing a complete wheel. The tire is installed by heating it as a result of which its diameter expands so that the tire can be positioned on the wheel. When the tire cools, it shrinks and is held in place on the wheel through a shrink fit. A worn tire can be removed by heating it again.

Methods and systems for induction heating of a physical object are well known. A condition, necessary for inductively heating a physical object, is that the physical object comprises an electrically conductive material. The operation of heating is based on inducing an electrical current in the electrically conductive material. Owing to the finite Ohmic resistivity of the electrically conductive material, the induced current generates heat in the electrically conductive material. The rate of heat generation at a certain location at the electrically conductive material is proportional to the square of the magnitude of the current density at that location, and proportional to the resistivity at that location.

Consider a physical object with an electrically conductive material and comprising a hole, such as a steel rolling-elements bearing. The hole of the rolling-elements bearing is determined by the inner diameter of the bearing's inner raceway. The physical object can be inductively heated by means of using the physical object as a secondary winding of a transformer.

As known, a transformer is a device that transfers electrical energy from one circuit to another by means of inductively coupled electrical conductors. A transformer typically has a core of high magnetic permeability. The primary coil has primary windings wound around the core. The primary windings are driven by a controllable current source. A varying current in the primary coil causes a varying magnetic field within the coil, i.e., within the core. A secondary coil of secondary windings wound around the core experiences the varying magnetic field, as a result of which a voltage is induced across the ends of the secondary coil. If the secondary coil is closed, e.g., by means of connecting a load between the ends of the secondary coil, a current is induced in the load.

The rolling-elements bearing is mounted instead of the secondary coil of the conventional transformer. The transformer's core passes through the hole formed by the inner raceway of the rolling-elements bearing. An electrical current is then induced in the closed loop formed by the configuration of the rolling-elements bearing. The Ohmic resistance of the loop gives rise to power dissipation in the form of heat, thus heating the rolling-elements bearing and causing it to expand.

A commercially available induction heater comprises a core, a primary winding around the core, and a power supply to supply a current to the primary coil. The core can be taken apart in order to position the rolling-elements bearing, so that the loop formed by the core upon being assembled and the loop of the inner raceway of the rolling-elements bearing interlock. For example, the core is made of a first part shaped as the letter “U” and a second part shaped as the letter “I”. Putting the “I” across the ends of the “U” results topologically in a letter “O”: a loop.

There are several issues to consider with regard to operational use of an induction heater.

One issue is a remnant magnetization of the physical object as a result of induction heating. If the physical object comprises ferromagnetic material, or if the electrically conductive material is ferromagnetic itself, the exposure to the magnetic fields may lead to an undesired permanent magnetization of the physical object. One way of solving this is to control the alternating electrical current in the primary coil, e.g., by means of gradually decreasing the magnitude of this current at the end of the heating process. Alternatively, one controls the current via a switched-mode power supply connected to the primary coil. A switched-mode power supply normally switches a semiconductor power switch between conduction and cut-off with a variable duty cycle, whose average is the desired output power. The switched-mode power supply is operated at a sufficiently high frequency (orders of magnitude: 10 kHz-100 kHz) so that a low magnetic flux density is created in the core and in the physical object. This avoids the need for demagnetization after the physical object has been inductively heated. Switched-mode power supplies are well known and need not be discussed here in further detail.

Another issue relates to the physical and geometrical parameters of the physical object. In order for the physical object to expand sufficiently, its temperature has to be raised a certain number of degrees to a calculated target temperature. Preferably, the temperature is uniform, or varies only slightly, throughout the physical object in order to avoid excessive stress as a result of one portion expanding farther than another portion. The target temperature can be reached if the inductively generated heat in the physical object is larger, across the range of temperatures achieved, than the heat losses as a result of cooling, e.g., through radiation or convection of the ambient air. As to the latter, the physical object can be wrapped in insulating material in order to reduce heat losses through radiation and convection. Whether or not the target temperature is reached, depends on the amount of power that is converted into heat, the heat capacity of the physical object, the physical object's dimensions, the rate of heat transport within the physical object, the size of the area of its surface exposed to the ambient air, etc.

Yet another issue is the time needed to reach the target temperature. For example, it will take more time in order to heat a large steel rolling-elements bearing than a smaller one, using the same induction heater. For example, the heat capacity of the larger bearing (i.e., the amount of heat needed in order to raise the temperature by one unit) is higher than the heat capacity of the smaller bearing. As a result more energy needs to be pumped into the larger bearing than into the smaller bearing. If the same induction heater is used, the time needed to heat up the larger bearing is longer than the time needed to heat up the smaller bearing to the same temperature.

Still another issue is the fact that the higher the power of the induction heater, the more power is consumed in operational use, the more bulky and heavier it becomes and the more difficult it becomes to move it around and to position it accurately.

As above considerations illustrate, the process of properly heating a physical object, by means of an induction heater, is a delicate technique, which almost borders on art, especially with respect to large physical objects, such as rolling-elements bearings that accommodate the shaft carrying the blades of an industrial-size wind-turbine.

### SUMMARY OF THE INVENTION

In view of the above, the inventors now propose a modular induction heater system using multiple induction heaters arranged in relation to a physical object to be heated. This would enable the use of multiple smaller induction heaters than a single conventional induction heater. The simultaneous use of multiple induction heaters to heat the same physical object is not a straightforward exercise.

One problem to be solved is that the individual currents induced by individual induction heaters within the same physical object should be properly controlled with regard to polarity, frequency and magnitude in order to avoid that their combination gives a too low net result, e.g., a zero net current. This effect is best understood by comparing the use of multiple induction heaters to the scenario of a three-phase electric power system, wherein the neutral conductor carries no net current if the loads are evenly distributed among the phases.

Another problem is the following. Consider a pair of induction heaters, each with its own switched-mode power supply. As mentioned above, the use of such power supply makes a demagnetization step unnecessary. Assume further that the individual polarity, magnitude and frequency of the currents are properly controlled at the individual induction heaters so as to avoid that the induced currents produce a zero net current. Now, a switched-mode power supply switches a semiconductor power switch between saturation/conduction and cut-off at a very high frequency. If one of the induction heaters switches a fraction of a second earlier than the other one, a change in the current induced by the early-switching induction heater is inductively coupled, via the physical object, to the primary coil of the other induction heater. The result is undesired interference among the primary coils, possibly leading to uncontrolled oscillations in the induced currents, and to possibly blowing up the induction heater that picks up the magnetic field caused by the current induced by the early-switching induction heater. It is almost impossible to synchronize the operations of the switched-mode power supplies with such a good accuracy, that an undesired interference can be ignored when using two or more induction heaters simultaneously. It is even shown that the variance of the turn-on time and/or turn-off time of individual ones of a batch of semiconductor switches, made in the same process, is large enough to cause problems, even if they are commonly controlled. For these reasons, one does not use, in practice, a configuration with multiple induction heaters for heating the same physical object.

Therefore, the inventors propose a modular system for inductively heating a physical object that comprises an electrically conductive material. A first basic embodiment of a modular system according to the invention comprises a first primary coil around a first core for inducing a first electrical current in the electrically conductive material, and a second primary coil around a second core, different from the first core, for inducing a second electrical current in the electrically conductive material. The modular system further has a power supply module connected to an electrically parallel arrangement of the first and second primary coils.

Accordingly, instead of attempting to control different power supplies of different induction heaters, the invention drives the first and second primary coils synchronously. The invention uses a single power supply module to drive two or more primary coils, each primary coil wound around a different core, in parallel. As a result, according to this basic configuration, the first and second electrical currents are synchronized. The primary coil windings and placement of the coils are such that a cooperating magnetic field is created.

As a consequence, relatively large physical objects, e.g., a rolling-elements bearing with a diameter of 2 meters, can be efficiently heated according to the invention by using multiple small induction heaters that are all driven in parallel from the same power supply.

In an embodiment of the system of the invention, the power supply module comprises a switched-mode power supply. The switched-power supply has a component configured for being switched between on and off so as to generate a drive current. The drive current is supplied to a parallel arrangement of the primary coils.

As mentioned above, the use of a switched-mode power supply eliminates the need for a demagnetization step. As also mentioned above, a switched-mode power supply comprises a semiconductor power switch that is controlled with a variable duty cycle, whose average is the desired output power. In the invention, a single semiconductor power switch is being used to ensure that the currents through the primary coils, connected in parallel, are controlled in precise unison.

In a further embodiment, the power supply module comprises configuration means for selectively connecting, or disconnecting, at least one of the primary coils from the power supply. The configuration means comprises, e.g., one or more switches for selectively connecting and disconnecting a particular one or more of the primary coils. Alternatively, the configuration means comprises one or more sockets for selectively connecting or disconnecting a particular one or more of the primary coils by means of inserting or removing a corresponding plug attached to the supply line of the particular primary coil.

### BRIEF DESCRIPTION OF THE DRAWINGS

The invention is explained in further detail, by way of example and with reference to the accompanying drawings, wherein:

FIG. 1 is a block diagram of a system according to the invention;

FIG. 2a-2c are diagrams illustrating various spatial configurations for heating a rolling-elements bearing according to the invention using two induction heaters;

FIG. 3 is a table listing test results for the spatial configurations of FIG. 2a-2c;

FIG. 4a-4d are diagrams illustrating various spatial configurations for heating a rolling-elements bearing according to the invention using three induction heaters;

FIG. 5 is a table listing test results for the spatial configurations of FIG. 4a-4d;

FIG. 6 is a diagram of a spatial configuration for heating a rolling-elements bearing according to the invention using four induction heaters; and

FIG. 7 is a table with a test result for the spatial configuration of FIG. 6.

Throughout the Figures, similar or corresponding features are indicated by same reference numerals.

### DETAILED DESCRIPTION

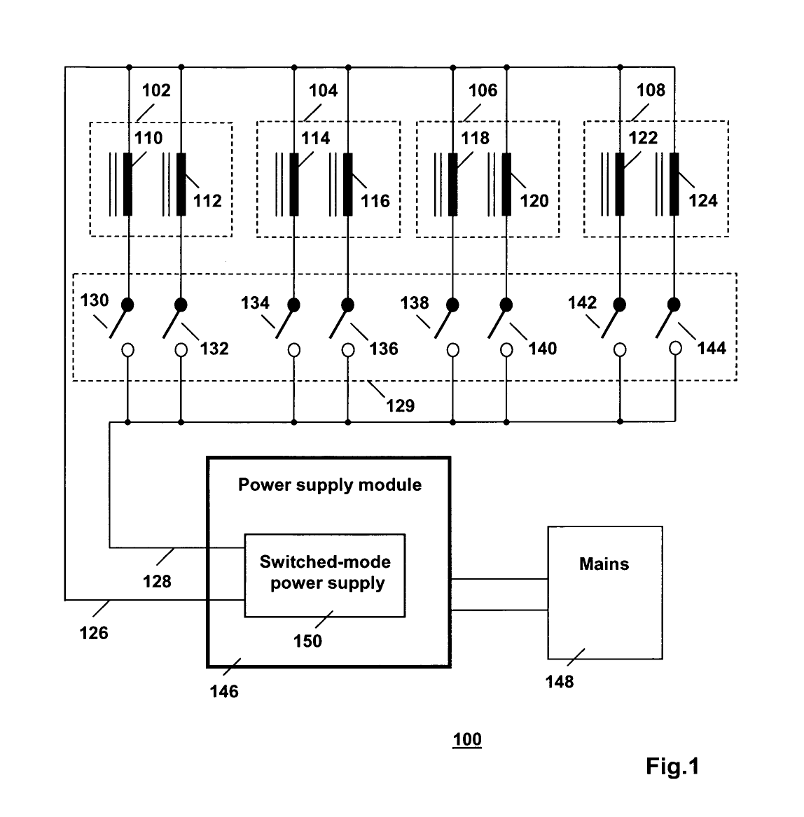

FIG. 1 is a block diagram of a system 100 according to the invention. The system 100 is configured for inductively heating a physical object (not shown here) that comprises an electrically conductive material (not shown here). The system 100 comprises multiple coil arrangements of primary coils. In the example shown, the system comprises a first coil arrangement 102, a second coil arrangement 104, a third coil arrangement 106 and a fourth coil arrangement 108. Each of the first, second, third and fourth coil arrangements 102-108 comprises, in the example shown, a respective pair of primary coils, wound around a respective core (not shown) of a high magnetic permeability. Each pair of primary coils is wound around the associated core in such a manner that they reinforce each other's magnetic field in operational use of the system 100. Instead of using a pair of primary coils, each of the coil arrangements 102-108 can have a single primary coil only. It is clear that any practical number of coil arrangements can be used in the invention each with one or more primary coils.

The first coil arrangement 102 comprises a first primary coil 110 and a second primary coil 112. The second coil arrangement 104 comprises a third primary coil 114 and a fourth primary coil 116. The third coil arrangement 106 comprises a fifth primary coil 118 and a sixth primary coil 120. The fourth coil arrangement 108 comprises a seventh primary coil 122 and an eighth primary coil 124. The primary coils 110-124 are electrically connected in parallel between a first supply line 126 and a second supply line 128 via configuration means 129 comprising a plurality of switches. The first primary coil 110 is connected to the second supply line 128 via a first switch 130. The second primary coil 112 is connected to the second supply line 128 via a second switch 132. The third primary coil 114 is connected to the second supply line 128 via a third switch 134. The fourth primary coil 116 is connected to the second supply line 128 via a fourth switch 136. The fifth primary coil 118 is connected to the second supply line 128 via a first switch 138. The sixth primary coil 120 is connected to the second supply line 128 via a sixth switch 140. The seventh primary coil 122 is connected to the second supply line 128 via a seventh switch 142. The eighth primary coil 124 is connected to the second supply line 128 via an eighth switch 144. The connections between the primary coils 110-124 and the first supply line 126 may also comprise switches there between.

The first and second supply lines 126 and 128 are connected to a power supply module 146. The power supply module 146 is operative to control the currents supplied to the coil arrangements 102-108 via the supply lines 126 and 128. The power supply module 146 itself receives its power from, e.g., a mains power system 148.

The configuration means 129 enables to selectively connect any of the primary coils 110-124 to the second supply line 128 or to selectively disconnect each of the primary coils 110-124 from the second supply line. Accordingly, the system 100 has a modular configuration so as to be able to use or remove one or more of the coil arrangements 102-108 or one or more of the primary coils 110-124. Those ones of the primary coils 110-124, which are connected to the second supply line 128 via the configuration means 129, are electrically connected in parallel between the first and second supply lines 126 and 128. As a result, the respective currents through the connected ones of the primary coils 110-124 are fully synchronized. The configuration means 129 is a feature for enabling to configure the system 100 for operational use depending on the number of primary coils needed. As such, the configuration means 129 is an optional feature, and can be omitted if the required number of primary coils is fixed. In the latter case, the primary coils are then permanently connected in parallel between the first and second supply lines 126 and 128.

The switches 130-144 may be manually operated switches. Alternatively, the switches 130-144 may be controlled via control circuitry (not shown) in the power supply module 146 upon the control circuitry receiving user input for configuring the system 100. The configuration means 129 is shown in FIG. 1 as external to the power supply module 146. Alternatively, the configuration means 129 is accommodated at the housing of the power supply module 146. Instead of using the two-state switches 130-144 for connecting or disconnecting the first to eighth primary coils to the second supply line 128, one could use plugs and matching sockets.

Preferably, the power supply module 146 comprises a switched-mode power supply 150. As mentioned above, a demagnetization step is unnecessary when using a switching-mode power supply operating at a high enough frequency. Moreover, the operation of the switched-mode power supply 150 is based on switching a semiconductor power switch (not shown) with a variable duty cycle, whose average is the desired output power. The use of a single semiconductor power switch ensures that the currents through those among the primary coils 110-124, which are connected in parallel between the first and the second power supply lines 126 and 128 via the connection means 129, are precisely synchronized.

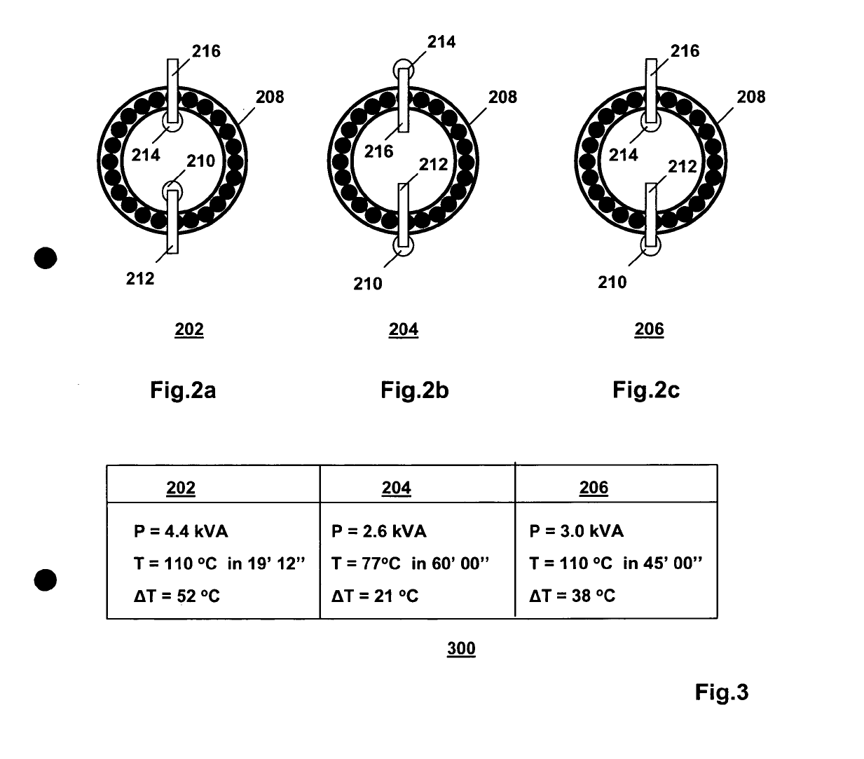

FIG. 2a-2c illustrate various spatial configurations 202, 204, 206 for heating a rolling-elements bearing 208 using the approach described above for the system 100 of FIG. 1 according to the invention and employing a first primary coil 210 wound around a first core 212, and a second primary coil 214 wound around a second core 216. The first primary coil 210 and the second primary coil 214 receive their primary currents from the same power supply module 146. In a first spatial configuration 202, the first primary coil 210 and the second primary coil 214 are positioned near the inner boundary of the inner raceway of the rolling-elements bearing 208. In a second spatial configuration 204, the first primary coil 210 and the second primary coil 214 are positioned near the outer boundary of the outer raceway of the rolling-elements bearing 208. In a third spatial configuration 206, the first primary coil 210 is positioned near the outer boundary of the outer raceway of the rolling-elements bearing 208, and the second primary coil 214 is positioned near the inner boundary of the inner raceway of the rolling-elements bearing 208. The windings of the first primary coil 210 and the windings of the second primary coil 214 are such, that the magnetic fields induced by the first primary coil 210 and the second primary coil 214, reinforce each other.

FIG. 3 is a table 300 listing the results of tests, conducted on a particular type of the rolling-elements bearing 208 using the three spatial configurations 202, 204, 206 of FIG. 2a-2c. The power supplied to the parallel arrangement of the primary coils is indicated with the capital letter “P”. The capital letter “T” indicates the maximum temperature reached in the time period specified in minutes and seconds. The maximum temperature difference existing between two locations on the rolling-elements bearing 208 after that time period is indicated by “ΔT”.

In the first and second spatial configurations 202, 204, the first and second primary coils 210, 214 are both located either near the inner raceway of the rolling-elements bearing 208 or near the outer raceway of the rolling-elements bearing 208. In these spatial configurations 202, 204, one of the raceways, which is nearer to the primary coils 210, 214 than the other raceway, may serve as a magnetic shield. That is, the raceway, nearer to the primary coils 210, 214 than the other raceway, prevents the magnetic fields, generated by the primary coils 210, 214, from reaching the rolling elements and the other raceway.

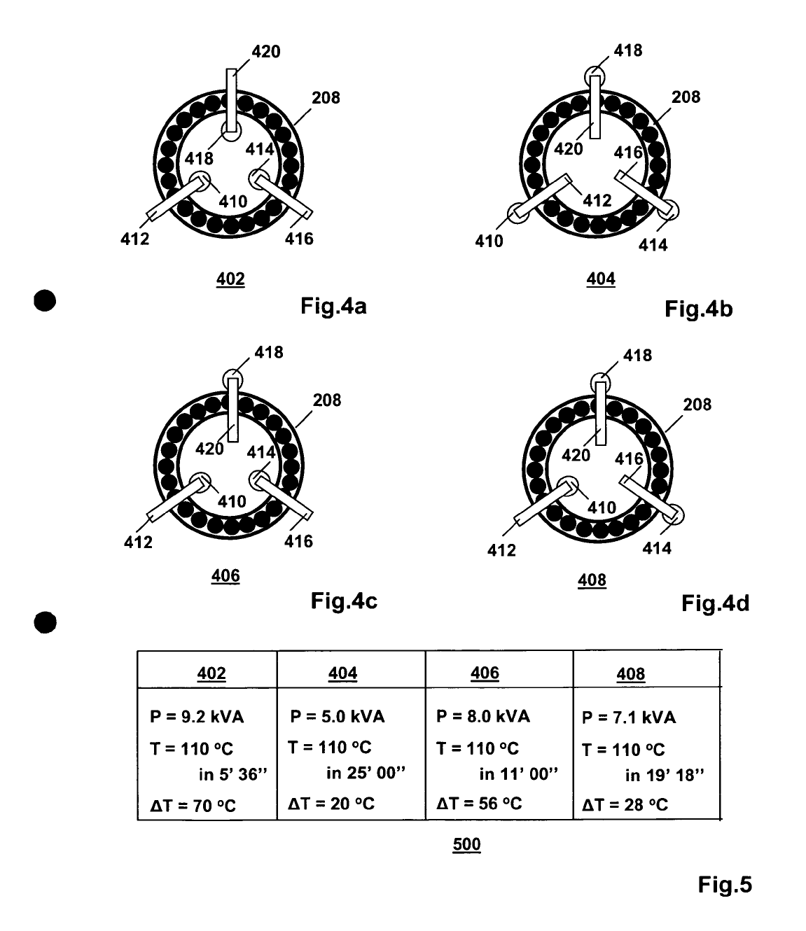

FIG. 4a-4d illustrate four spatial configurations 402, 404, 406, 408 for heating the rolling-elements bearing 208 using the approach described above for the system 100 of FIG. 1 and employing a first primary coil 410 wound around a first core 412, and a second primary coil 414 wound around a second core 416, and a third primary coil 418 wound around a third core 420. In a first configuration 402, all the three primary coils 410, 414 and 418 are positioned near the inner raceway of the rolling-elements bearing 208. In a second configuration 404, all the three primary coils 410, 414 and 418 are positioned near the outer raceway of the rolling-elements bearing 208. In a third configuration 406, the first and second primary coils 410, 414 are positioned near the inner raceway of the rolling-elements bearing 208, and the third primary coil 418 is positioned near the outer raceway of the rolling-elements bearing 208. In a fourth configuration 408, the second and third primary coils 414, 418 are positioned near the outer raceway of the rolling-elements bearing 208, and the first primary coil 410 is positioned near the inner raceway of the rolling-elements bearing 208.

FIG. 5 is a table 500 listing the results of tests, conducted on the particular type of the rolling-elements bearing 208 also used in the tests described with reference to FIGS. 2a-2c and 3, now using the four spatial configurations 402, 404, 406, 408 according to FIG. 4a-4d. The test results appear to favor the configuration 408, having two of the three primary coils positioned near the outer raceway of the rolling-elements bearing 208 and one of the three primary coils positioned near the inner raceway.

A tentative conclusion may be drawn in the sense that it is advantageous, in view of the shorter heating time and smaller deviation from the uniform temperature distribution, to position some of the active primary coils near the outer raceway of the rolling-elements bearing 208 and others of the active primary coils near the inner raceway of the rolling-elements bearing 208. This may be explained as that such distribution overcomes the shielding effect at least partly. It also appears favorable to have a first number of primary coils near the outer raceway of the rolling-elements bearing 208 and a second number of primary coils near the inner raceway of the rolling-elements bearing 208, wherein the first number is higher than the second number. This could be explained by considering the fact that the amount of material of the outer raceway of the rolling-elements bearing 208, is larger than the amount of material of the inner raceway of the rolling-elements bearing 208. The inner and outer raceways of the rolling-elements bearing 208 have, therefore, different heat capacities. In order to heat the inner and outer raceways of the rolling-elements bearing 208 to substantially the same temperature within a given time period, more heat is to be pumped into the larger part than into the smaller part.

Note the large temperature difference ΔT of 70° C., obtained in the first configuration 402 of FIG. 4a. The inner raceway of the rolling-elements bearing 208 is directly near all primary coils 410, 414, 418. The inner raceway of the rolling-elements bearing 208 shields the outer raceway of the rolling-elements bearing 208. The inner raceway of the rolling-elements bearing 208 has a lower heat capacity than the outer raceway of the rolling-elements bearing 208. The inner raceway of the rolling-elements bearing 208 will therefore reach a higher temperature much faster than the outer raceway of the rolling-elements bearing 208. As a result, the thermal expansion of the inner raceway of the rolling-elements bearing 208 is larger than the thermal expansion of the outer raceway of the rolling-elements bearing 208. This implies that the rolling elements, e.g., balls, of the rolling-elements bearing 208 exert an increasingly larger pressure on the surfaces of the inner and outer raceways with increasing temperature. Accordingly, one should be aware of the risk of damaging the surfaces of the inner and outer raceways when heating the rolling-elements bearing 208 in the spatial configuration 402.

It should also be noted that if the outer raceway of the rolling-elements bearing 208 heats up quicker and expands more than the inner raceway of rolling-elements bearing 208 there is the risk of one or more of the rolling-elements dropping out of the rolling-elements bearing 208. It is thus important to keep the temperature difference between the inner and outer raceway under control.

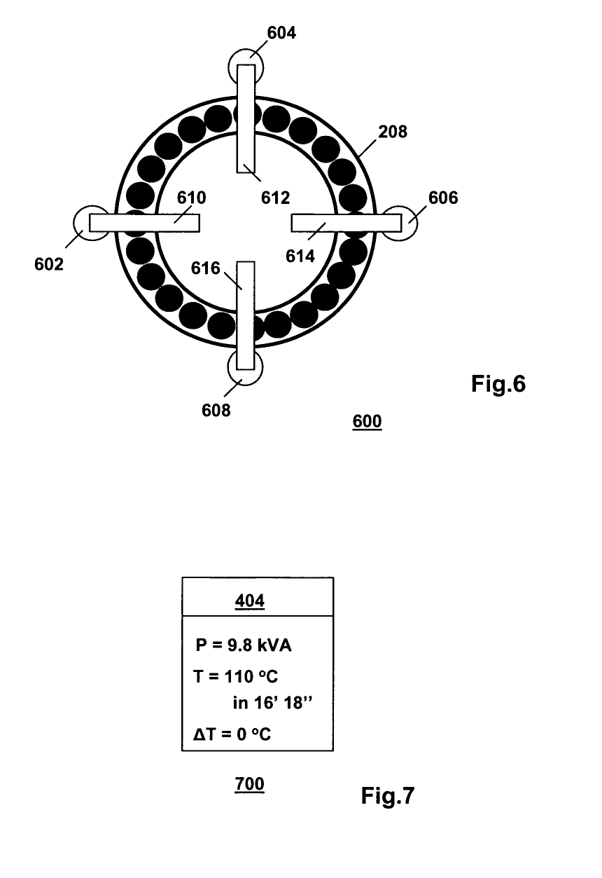

FIG. 6 illustrates yet another spatial configuration 600 for heating the rolling-elements bearing 208 using the approach described above for the system 100 of FIG. 1, now using four primary coils 602, 604, 606, 608, all positioned near the outer raceway of the rolling-elements bearing 208. The first primary coil 602 is wound around a first core 610. The second primary coil 604 is wound around a second core 612. The third primary coil 606 is wound around a third core 614. The fourth primary coil 608 is wound around a fourth core 616.

FIG. 7 is a table 700 with a result of a test, conducted on the particular type of the rolling-elements bearing 208 also used in the tests described with reference to FIGS. 2a-5, now using the configuration of FIG. 6 with the four primary coils all positioned near the outer raceway of the rolling-elements bearing 208. As can be seen, for the specific rolling element bearing 208 used in these examples, the configuration and spatial configuration of FIG. 6 seems to be optimal with an attained target temperature in a reasonable time with a ΔT of 0° C. between the outer and inner raceways.

Accordingly, the person skilled in the art may vary the number of cores, the number of primary coils, wound around different cores and driven in parallel, and their position relative to the physical object, depending on the size, shape and heat capacity, of the physical object and depending on the power ratings of the primary coils. If the heat capacity per unit volume of the physical object varies from location to location at the physical object, a non-uniform spatial distribution of coils relative to the physical object may be considered.

The examples illustrated in FIGS. 2a-7 show only a single primary coil per individual core. It is clear that two or more primary coils can be used per individual core, with all the primary coils of all cores being connected in parallel and driven from a single power supply module, e.g., one with a switched-mode power supply.

1. A system for inductively heating a physical object that comprises an electrically conductive material, the system comprising:
a first primary coil around a first core for inducing a first electrical current in the electrically conductive material;
a second primary coil around a second core, different from the first core, for inducing a second electrical current in the electrically conductive material; and
a power supply module connected to an electrically parallel arrangement of the first and second primary coils for driving the first and second primary coils in parallel.

2. The system of claim 1, wherein:
the power supply module comprises a switched-mode power supply;
the switched-power supply has a component configured for being switched between on and off so as to generate a drive current; and
the drive current is supplied to a parallel arrangement of the first and second primary coils.

3. The system of claim 1, wherein the power supply module comprises configuration means for selectively connecting, or disconnecting, at least one of the first and second primary coils from the power supply.

4. (canceled)

5. A method of inductively heating a physical object that comprises an electrically conductive material, the method comprising:
using a first primary coil around a first core for inducing a first electrical current in the electrically conductive material;
using a second primary coil around a second core, different from the first core, for inducing a second electrical current in the electrically conductive material; and
driving the first and second primary coils electrically connected in parallel from a single power supply module.

6. The method of claim 5, wherein:
the power supply module comprises a switched-mode power supply.
the switched-power supply has a component configured for being switched between on and off so as to generate a drive current; and
the drive current is supplied to a parallel arrangement of the first and second primary coils.
